(19) United States
(12) Patent Application Publication
(10) Pub. No.: US 2008/0274783 A1
(43) Pub. Date: Nov. 6, 2008

(54) SESSION PLAY WITH HIGH VOLATILITY BET OPTION

(76) Inventors: Jay S. WALKER, Ridgefield, CT (US); Robert C. TEDESCO, Fairfield, CT (US)

Correspondence Address: Walter Digital Management, LLC, 2 High Ridge Park, Stamford, CT, 06905, US

(21) Appl. No.: 12/174,466

(22) Filed: Jul. 16, 2008

Related U.S. Application Data
(63) Continuation-in-part of application No. PCT/US08/66584, filed on Jun. 11, 2008.
Application No. PCT/US08/66584 is a continuation-in-part of application No. 11/270,016, filed on Nov. 9, 2005.
(60) Provisional application No. 60/950,036, filed on Jul. 16, 2007.
(60) Provisional application No. 60/986,382, filed on Nov. 8, 2007.
(60) Provisional application No. 60/974,901, filed on Sep. 25, 2007.
(60) Provisional application No. 60/957,021, filed on Aug. 21, 2007.
(60) Provisional application No. 60/952,728, filed on Jul. 30, 2007.
(60) Provisional application No. 60/949,962, filed on Jul. 16, 2007.
(60) Provisional application No. 60/990,094, filed on Nov. 26, 2007.
(60) Provisional application No. 61/012,230, filed on Dec. 7, 2007.

(51) Int. Cl. A63F 9/24; G06F 17/00

(52) U.S. Cl. 463/13; 463/43

(57) ABSTRACT

A method for improving gambling sessions includes providing one or more conditional wagers with heightened volatility for the player. The player may purchase the session through appropriate purchasing forms and receive payouts at the end of the session. Conditions applied to the wager may include session balances, cards dealt to the player, timing within the session, and the like.

### RELATED APPLICATIONS

The present application is a continuation in part of PCT application WOUS08/66584, filed Jun. 11, 2008, which is hereby incorporated by reference in its entirety

The present application is also a continuation in part of U.S. patent application Ser. No. 11/270,016, filed Nov. 9, 2005, published on Feb. 23, 2006 as U.S. Patent Publication No. 2006/0040730, which is hereby incorporated by reference in its entirety

The present application also claims the benefit of and priority to U.S. Provisional Patent Application No. 60/950,036, filed Jul. 16, 2007, entitled METHODS AND APPARATUS FOR FACILITATING CONDITIONAL BETS IN A FLAT RATE PLAY SESSION, which is hereby incorporated by reference in its entirety

The present application is also related to the following patent and applications:

U.S. Provisional Patent Application Ser. No. 60/986,382 filed Nov. 8, 2007;

U.S. Provisional Patent Application Ser. No. 60/974,901 filed Sep. 25, 2007;

U.S. Provisional Patent Application Ser. No. 60/957,021, filed Aug. 21, 2007;

U.S. Provisional Patent Application Ser. No. 60/952,728, filed Jul. 30, 2007;

U.S. Provisional Patent Application Ser. No. 60/949,962, filed Jul. 16, 2007;

U.S. Provisional Patent Application Ser. No. 60/948,848, filed Jul. 10, 2007;

U.S. Provisional Patent Application Ser. No. 60/943,171, filed Jun. 11, 2007;

U.S. Provisional Patent Application Ser. No. 60/990,094, filed on Nov. 26, 2007;

U.S. Provisional Patent Application Ser. No. 61/012,230, filed on Dec. 7, 2007;

PCT Application No. WOUS08/50389, filed Jan. 7, 2008;

U.S. patent application Ser. No. 12/098,074, filed Apr. 4, 2008;

U.S. Pat. No. 6,077,163, issued Jun. 20, 2000;

U.S. patent application Ser. Nos. 11/293,016, filed Dec. 2, 2005 and 11/270,016, filed Nov. 9, 2005;

U.S. Provisional Patent Application Nos. 60/715,666, filed Sep. 9, 2005 and 60/865,273, filed Nov. 10, 2006; and

PCT Application No. WOUS05/28383 filed Aug. 10, 2005.

Each of the above applications and patent is incorporated by reference in its entirety.

### FIELD OF THE INVENTION

The present invention is related to session play of a casino game and more particularly to playing a session with a conditionally available increased volatility bet option.

### BRIEF DESCRIPTION OF THE DRAWINGS

FIG. 1 illustrates a top plan view of a blackjack table suitable for use with at least one embodiment of the present disclosure.

FIG. 2 illustrates a flow chart illustrating a method of implementing at least one embodiment of the present disclosure.

FIGS. 3A & 3B illustrate session chips for use in the embodiment of FIG. 2.

FIG. 4 illustrates a top plan view of a second blackjack table suitable for use with a different embodiment of the present disclosure.

FIG. 5 illustrates a block diagram of a chip suitable for use with some embodiments of the present disclosure.

FIGS. 6 and 7 illustrate perspective views of the chip of FIG. 5 showing indicia used to mark the chip.

FIG. 8 illustrates a block diagram of components of the table of FIG. 4.

FIG. 9 illustrates an exemplary video poker machine suitable for use with the present disclosure.

FIG. 10 illustrates an exemplary slot machine suitable for use with the present disclosure.

FIG. 11 illustrates a flow chart outlining an exemplary method of the present disclosure.

FIG. 12 illustrates a screen shot of a display showing available conditional wagers.

### DETAILED DESCRIPTION OF THE INVENTION

The concept of session play was introduced prominently at the Global Gaming Expo (G2E) in Las Vegas 2006. The initial introduction applied the GUARANTEED PLAY™ product to a video poker machine. At G2E 2007, Blackjack with GUARANTEED PLAY™ and Video Slots with GUARANTEED PLAY™ were also introduced. Video poker and slot style machines inherently have a respectably high volatility that keeps a player's interest by dangling the prospect of jackpot style outcomes in front of the players so that they always feel like that they can end the session a winner. Games like Blackjack do not have the same high volatility. Players with certain personality types may not enjoy session play embodied in such low volatility games. The present disclosure provides a way to introduce higher volatility bets into session play while still keeping the cost of the session at an attractive price point. While it is particularly contemplated for low volatility games like Blackjack, it is not so limited and may be applied to any session play (e.g., baccarat, video poker, or video slot session play).

In particular, the present disclosure introduces a conditionally available higher volatility wager that allows the player to win a larger sum than is otherwise allowed within the session. The terms of the condition and the terms of the payout on such a conditional wager are manipulated to keep the price point of the session attractive to players while providing a desired profit for the gaming establishment. A few examples are provided now to assist the reader.

In one particularly contemplated embodiment the player places an “all-in” wager approximately half way through the session. If the player loses the all-in wager, the player loses all the funds available to the player as part of the session. If the player wins, the player receives the purchase price of the session plus a small net win amount. In either event, the session ends. In the event the player lost, the player owes no money, but receives no payout.

In another particularly contemplated embodiment, the player places a booster wager equal to three times the normal maximum wager for the session. If the player wins, the player is paid on 1:1 odds, but because the base wager is much higher than normal, the payout is likewise greater than the player would otherwise be able to make. If the player loses, the player loses the larger base wager. Play may continue according to the normal rules of the session.

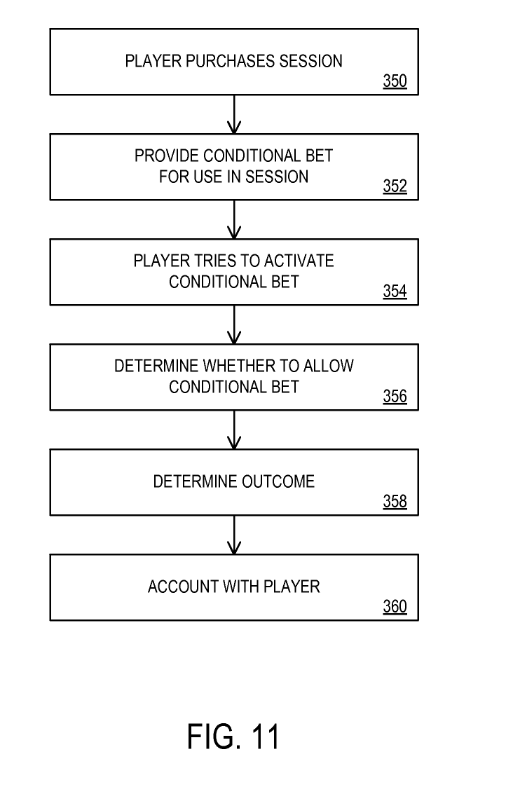

Before addressing the particulars of the conditional wager, an explanation of session play is provided. The discussion of session play starts with table based blackjack and then is discussed in relation to electronic gaming devices. The discussion of the conditional wager begins below with reference to FIG. 11.

In traditional blackjack, a player determines a wager for each hand, places the wager, helps resolve the hand that the player is dealt after game initiation, and collects any winnings. The player repeats the process for each hand. A side effect of this process is that the player may not know how long or how many hands the player will be able to play for a given budget. For example, if the player plays poorly or has a string of bad luck, the player may exhaust her budget rapidly in a minimal number of hands. Conversely, a player who plays well or has a string of good luck may extend her playing time through a large number of hands, and may even walk away from the table with more money than she had before playing.

In session play, a player may purchase a session of a predetermined number of blackjack hands for a predetermined price and play such hands at a blackjack table. In some embodiments, each such hand may be restricted to a predetermined maximum wager amount. Thus, based on the parameters of the session, the player knows how many hands the player will be able to play at a given wager without having to worry about the vagaries of luck or how skillfully the player is able to play. In an exemplary embodiment, the predetermined price of the session is less than the cost of buying each hand individually.

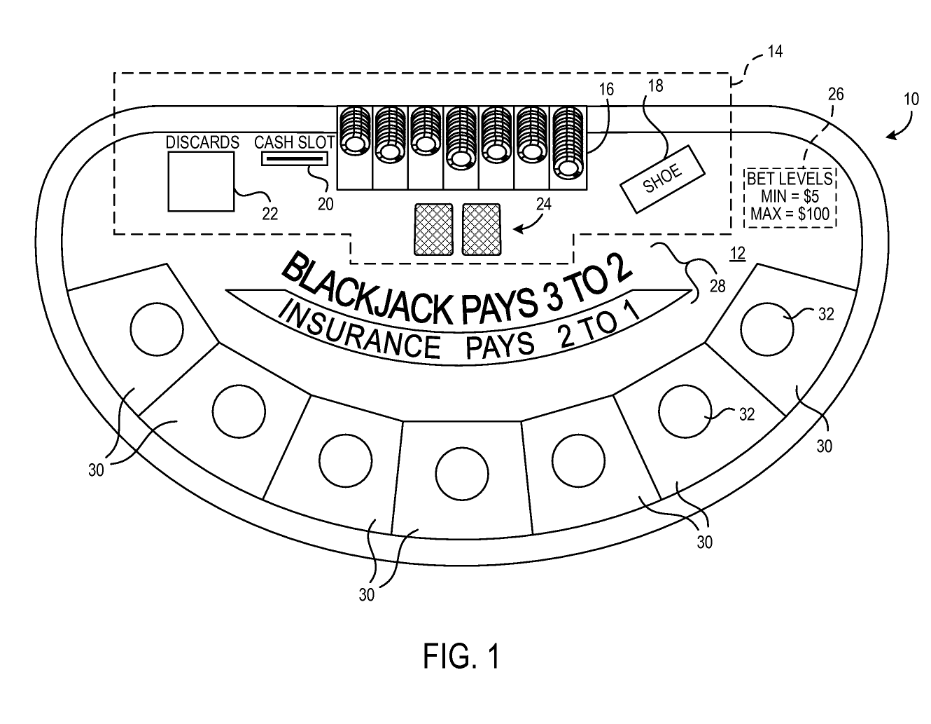

The concepts of session play may be applied to a simple blackjack table 10 as illustrated in FIG. 1. The blackjack table 10 may have a planar top surface 12. A dealer station 14 is positioned on one side of the blackjack table 10. The dealer station 14 may include a place for the dealer to stand, a chip rack 16, a card shoe 18, a slot 20 for a drop box (not shown, but typically secured to the underside of the table 10), a discard collection area 22, and a dealer hand area 24. Note that not all of these elements are necessary for a dealer station 14. Likewise, additional elements or repositioning of these elements is contemplated as being within the scope of the present disclosure. For example, a device that provides an alert when the dealer is dealt a natural blackjack could be added.

The chip rack 16 includes tubes or slots sized to handle a number of chips as is well understood. In practice, chips of differing denominations are placed in different tubes or slots. The dealer removes chips to pay winning wagers and collects chips into the chip rack 16 as the dealer collects losing wagers.

The shoe 18 may include a shuffler or just dispense cards as is well understood in the casino industry. The shoe 18 may be a single deck shoe or a multi-deck shoe as desired, although usually shoes will be used only for four or more decks.

The slot 20 provides a place for dealers to insert cash into the drop box. Typically, the dealer accepts cash from a player, provides chips to the player corresponding to the cash received and inserts the cash into the slot 20. A pit boss or other supervisory personnel may view and/or record the transaction to assist in the accounting of the gaming establishment. This process and the use of such drop boxes are well understood in the casino industry.

Discard collection area 22 may be used to collect used cards after completion of a hand. The cards may be stacked neatly on the table surface or passed through an aperture into a locked container for later inspection and disposal as is well understood. Other discard collection mechanisms are also possible without departing from the scope of the present disclosure.

Dealer hand area 24 is the space into which the dealer deals his own hand. The dealer hand area 24 may have square indicia printed on the top surface 12 so that it is clear that cards placed proximate thereto are the dealer's cards. Still other techniques of denoting the dealer hand area 24 are also contemplated.

A placard 26 may indicate the minimum and maximum bets, available sessions, as well as any other rules particular to the blackjack table 10. Other rule indicia 28 may be printed on the top surface 12 as is well understood. A plurality of player stations 30 may be positioned at the table on a curved side opposite the dealer station 14. Each player station 30 may have a betting circle 32 printed on the top surface 12 as is well understood.

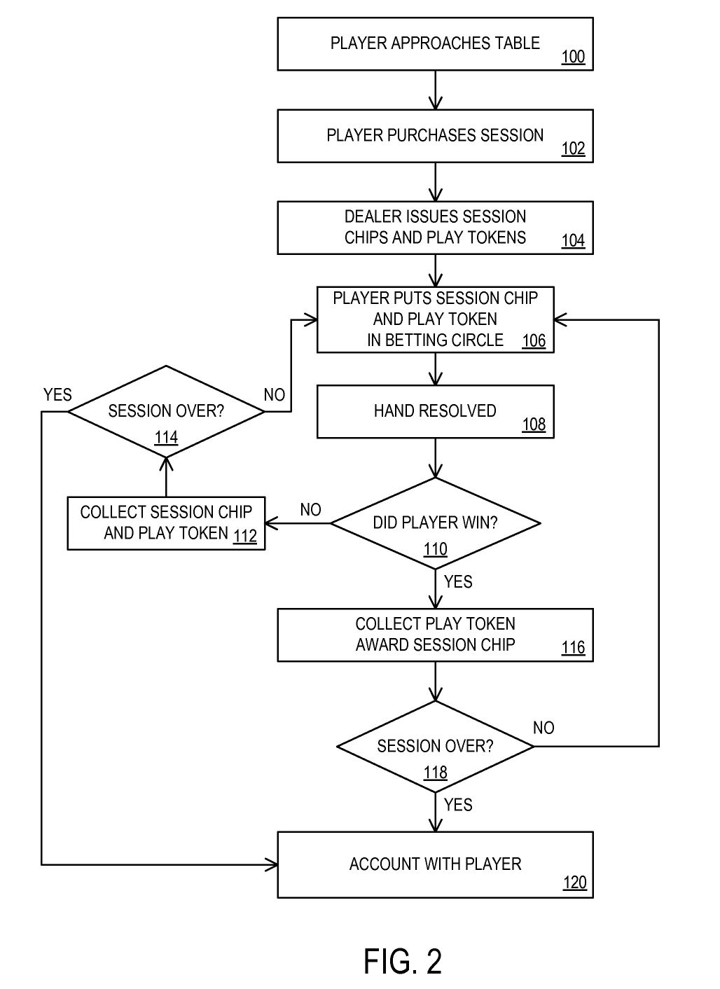

In a first embodiment whose methodology is illustrated in FIG. 2, the player approaches the blackjack table 10 (block 100). The player may view available sessions listed on the placard 26, verbally solicit a listing of available sessions from the dealer, or otherwise determine what sessions are available. Based on the available sessions, the player may purchase a session (block 102). The player may identify the session in myriad ways. The player may say she would like to buy a “50-hand session” or identify the session by a nickname or moniker displayed on the placard 26 (e.g., “Afternoon Blackjack Session”) or point to a session on the placard 26. To purchase the session, the player provides equity to the dealer, such as by providing the dealer cash. Alternatively, the player may provide cashable gaming chips, a receipt for comp points, a promotional voucher, a voucher purchased from a kiosk, a stored value card, cashier station or through a web interface, a cashless gaming receipt, a line of credit marker from the casino, or other equity mechanism as is well understood. Based on the session purchased, the dealer may then issue the player session chips and play tokens (block 104).

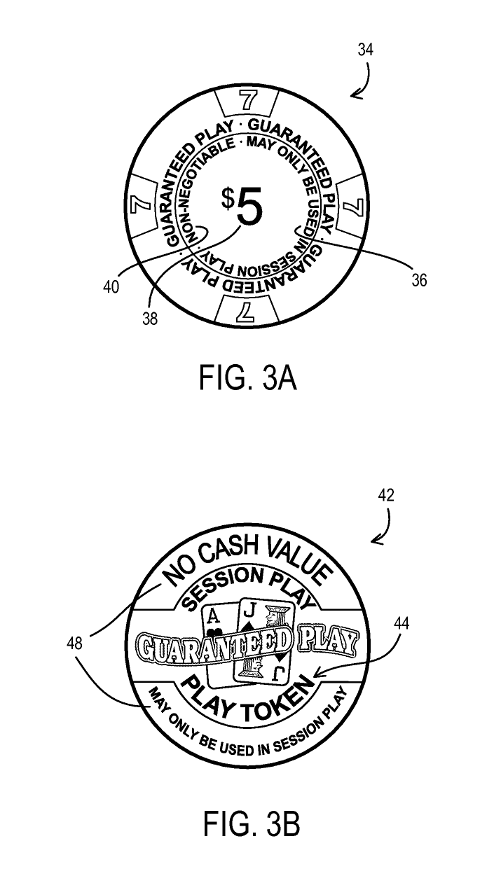

For the sake of example, the player purchases thirty hands of five dollar wager blackjack for twenty dollars. The dealer collects the twenty dollars from the player, deposits the money in the slot 20 and issues the player one hundred fifty dollars of session chips 34 (see FIG. 3A) and thirty play tokens 42 (see FIG. 3B). Play tokens 42 represent a number of hands purchased by the player, although different embodiments may vary the use of play tokens to extend the session as explained in greater detail below. The value of the session chips 34 initially provided is called the initial value or initial balance.

Turning to FIG. 3A, a session chip 34 may include indicia 36 indicating that the chip is a session-only chip, wager indicia 38 indicating the value of the wager, and rules indicia 40 indicating any rules associated with the session chip 34 such as that the session chip 34 is non-negotiable (i.e. has no cash value). Note that session chips 34 may come in a variety of denominations to facilitate payouts. Note further, that a player position and/or table identifier may be indicated through indicia on the chip 34 (e.g., as illustrated, the chip belongs to player position seven).

Returning now to a discussion of FIG. 2, session play commences and the player places a session chip 34 and play token 42 in the betting circle 32 (block 106). The dealer deals out the hands and resolves the hand of blackjack (block 108). Resolving the hand may involve providing additional cards to the player if the player indicates a hit, adding cards to the dealer hand according to the house rules (e.g., dealer hits on soft seventeen) as is well understood. Special wagers such as splitting and doubling down are addressed below.

The dealer determines if the player won (block 110). If the player lost, then the dealer collects the session chip 34 (block 112) and play token 42 and determines if the session is over (block 114). The session is over if the player has exhausted all of his play tokens 42. If the answer to block 114 is no, the session is not over (i.e., the player still has one or more play tokens 42), then the process repeats for the next hand. If however, the session is over, then the dealer accounts with the player (block 120) as explained in greater detail below. If the answer to block 110 is yes, the player won, then the dealer collects the play token 42 and awards the player a session chip 34 of the appropriate denomination (block 116). Note that wins and losses change the number of session chips 34 possessed by the player. Once the player has won or lost, the player effectively has a running balance of session chips 34.

The dealer determines if the session is over (block 118) in much the same manner described above with reference to block 114. If the answer to block 118 is no, then the process repeats as indicated. If the answer to block 118 is yes, the session is over, then the dealer accounts with the player (block 120). Specifically, the player presents all of his collected session chips 34 to the dealer. The dealer then adds up the values on the session chips 34 (i.e., the running balance runs no longer and becomes a final balance or winning total) and compares this winning total to the initial value of the session chips 34 issued to the player. If the winning total exceeds the initial value, the dealer may then provide the player chips having a cash value equal to the winning total minus the initial value.

As the above explanation may not be readily intuitive, an example is provided. Extending the example provided above, assume the player won twenty-five times during the thirty hand session. The player's total (sometimes called a “running balance” herein) would be two hundred fifty dollars (assuming that winning hands pay one to one as is common in blackjack, and the player received no natural blackjacks and no pushes and there have been no splits or double downs). This amount of two hundred fifty dollars becomes the winning total. In contrast, the initial value of the session chips is one hundred fifty dollars. The player would thus be paid $100 in cashable chips (e.g., $250-$150=$100). Suppose, instead of winning twenty-five times, the player lost twenty times and won ten times. The player's total would then be $100, which is less than the initial value of $150, so the player is paid nothing (and, in many embodiments, owes nothing), but has enjoyed about a half hour of game play.

If the session chips 34 have different denominations, it is relatively easy to account for pushes and blackjacks, which do not pay out at the same one to one odds as a win. While it is specifically contemplated that during the accounting step 120 the dealer will pay the player any winnings with conventional chips having a cash value (rather than the session chips 34), it is also possible that the dealer provides cash, a cashless gaming receipt, or other item that reflects the winnings of the player. For example, the winnings could be returned to the dealer to pay for a marker signifying a loan from the casino or other technique as desired.

Double downs and splits may require special rules to make the price point of the session attractive. In a first embodiment, these options are simply not available to a player. In a second embodiment, the player is allowed to use an additional one of her play tokens 42 and appropriate session chips 34 to signify the split or double down. Such usage has the effect of reducing the total number of hands that the player has in a session, but preserves the “action” purchased by the player for a given session in that the player is allowed to put the same amount of money into play during the session, but at the expense of total number of hands in the session. In a third embodiment, the player is provided a fixed number of special wager chips (not illustrated) which can be used for splits and double downs. In another embodiment, the player may split and/or double down whenever the player desires (according to the standard rules of blackjack about the availability of such wagers). Still other techniques for accommodating such wagers are also possible.

Some players may be tempted to keep a session chip 34 or a play token 42. While in the abstract, retention of such chips is not a problem, some players may introduce the chips in a later session so as to get an extra hand during a hot streak or increase the amount paid to the player during the accounting step 120. To prevent this sort of player fraud, or simply to assist with accounting, the dealer may be provided specially sized session and/or play token trays or tubes within the chip rack 16. The tube is sized to accommodate a fixed number of session chips 34 or play tokens 42. If, during the accounting step 120 (or other time as desired), a tube is missing a chip, the dealer will easily be able to see that there is a chip missing. The dealer may speak to the player about the chip count, may alert a supervisor, or otherwise begin processes to account for the missing chip. Alternatively, the gaming establishment may not care if the players move chips around in this fashion and may not track such activity.

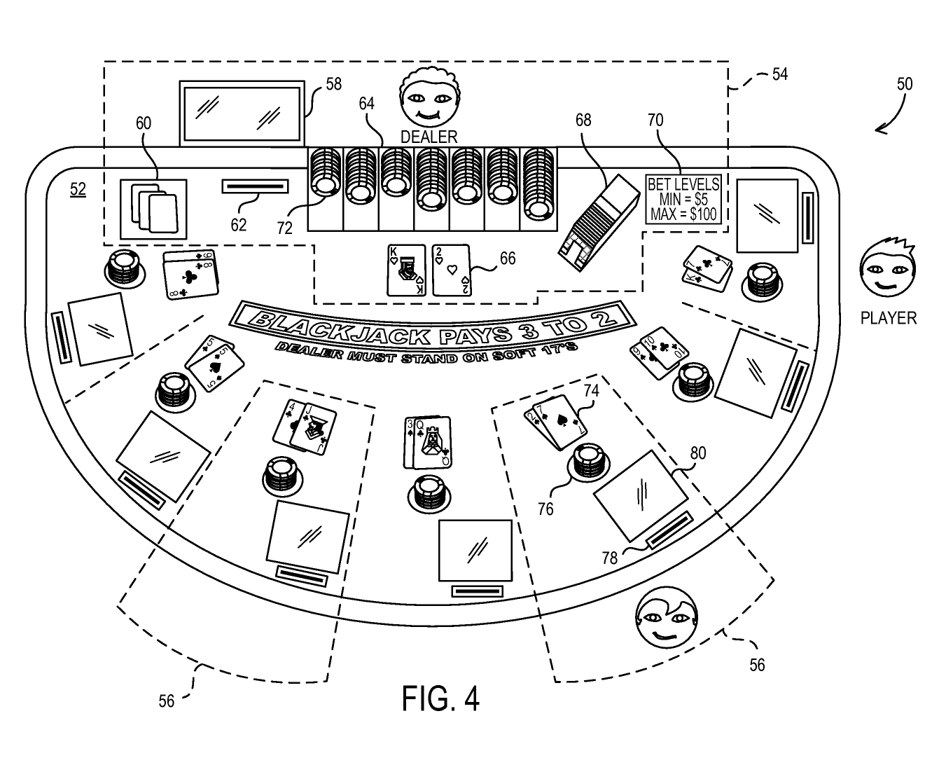

While the embodiment of FIGS. 1-3B is one way that a player may experience session play for blackjack, the embodiment of FIGS. 1-3B is a bit simplistic and does not take full advantage of improvements in table technology that simplify and facilitate tracking the session as it evolves. Thus, a more robust table 50 is illustrated in FIG. 4.

The table 50 has a planar top surface 52 on which game play takes place. The table 50 further has a dealer station 54 and at least one player station 56 (seven shown). The dealer station 54 has space for the dealer to stand or sit and may include a dealer monitor 58, a discard collection area 60, a slot 62, a chip rack 64, a dealer hand area 66, a shoe 68, and a placard 70. The discard collection area 60, slot 62, dealer hand area 66, and placard 70 are substantially similar to the discard collection area 22, slot 20, dealer hand area 24, and placard 26 previously described although variations on the structure and arrangement on the table 50 are contemplated and embraced by the present disclosure.

The dealer monitor 58 may be a display as that term is defined in the Rules of Interpretation and General Definitions set forth below. It is particularly contemplated that the dealer monitor 58 has touch screen functionality. Alternatively a keyboard or other input mechanism may be provided (not shown).

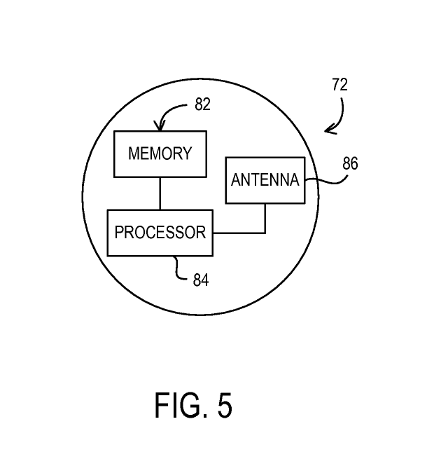

Chips 72 (also illustrated in FIG. 5) may be positioned in the chip rack 64 and used throughout the table 50. Chips 72 may appear visually similar to or identical to chips 34 (see FIG. 3A), but internally may include a radio frequency identification (RFID) tag or memory 82 with an electronic circuit or processor 84 and an antenna 86 (see FIG. 5). The chip 72 may include functionality similar or identical to those disclosed in U.S. Pat. Nos. 5,166,502; 5,676,376; 6,021,949; and 6,296,190, which are all incorporated by reference in their entireties. Gaming Partners International (GPI), of 1182 Industrial Road, Las Vegas, Nev. 89102 and Shuffle Master, Inc. of 1106 Palms Airport Drive, Las Vegas Nev. 89119 both sell RFID chips suitable for use with the table 50, although neither product is specifically required to practice the concepts of the present disclosure. The GPI chip uses a standard microchip made by Philips Semiconductors called the VEGAS S, each of which has a unique serial number. The gaming establishment (e.g., casino) or other entity may associate values with each serial number. The association may be in a look-up table or the like. Alternatively, the unique identifier may be encoded to include information therein. Likewise, the chips 72 may be color-coded or include other indicia, such as indicia 38 that indicate values to the player or dealer. The chips 72 may include further indicia 36, 40 similar to that previously described. In some embodiments, the value of a chip and/or other indicia displayed on the chip may be dynamically updated. For more information about chips with displays and dynamic updates to such chips, the interested reader is directed to U.S. Pat. No. 7,267,614 and U.S. patent application Ser. No. 12/067,694, filed Mar. 21, 2008 and PCT patent Application No. PCT/US08/57821 filed Mar. 21, 2008. Each of these applications and patent are incorporated by reference in its entirety.

In use, the electronic circuit 84 and antenna 86 act as a transponder capable of responding to an interrogator (not shown). In essence, the interrogator sends out an electromagnetic signal that impinges upon the antenna 86, exciting a current within electronic circuit 84. In response to the excited current, the electronic circuit 84 causes the antenna 86 to emit a second electromagnetic signal as a response, which is received by the interrogator. The second signal has identifying information about the chip 72 encoded therein such that the interrogator can identify the chip on receipt of the second signal. The second signal may be generated passively or actively. That is, in a first embodiment, the energy from the interrogation signal provides sufficient power for the electronic circuit 84 to use to send the second signal. In a second embodiment, the electronic circuit 84 may include a battery or other power source, which is used to power the generation of the second signal. While batteries have increasingly small footprints and longer lives, it is generally more practical to have a passive transponder.

Placement and movement of the chips 72 may be tracked with various interrogators. The chip rack 64 may be one such interrogator. An exemplary chip rack of this sort is made by GPI under the trade name CHIP BANK READER. Alternatively, the interrogators described in U.S. Pat. Nos. 4,814,589; 5,283,422; 5,367,148; 5,651,548; and 5,735,742—all of which are incorporated herein by reference in their entireties—could be used. Another RFID tag and interrogator suitable for use with at least some embodiments of the present disclosure are produced by Texas Instruments as the TAG-IT™ product line. Another alternate interrogator is discussed in U.S. Patent Application Publication 2006/0077036, which is also incorporated by reference in its entirety.

The shoe 68 may be an intelligent shoe such as the IS-T1™ and IS-B1™ or the MD1, MD2 sold by Shuffle Master or comparable devices. The shoe 68 may be able to determine which cards are being dealt to which player position through RFID technology, image recognition, a printed code on the card (such as a barcode), or the like. The particular technique used to recognize cards is not central to the present disclosure. Further information about intelligent shoes may be found in U.S. Pat. Nos. 5,941,769 and 7,029,009, both of which are incorporated by reference in their entireties and U.S. Patent Application Publications 2005/0026681; 2001/7862227; 2005/0051955; 2005/0113166; 2005/0219200; 2004/0207156; and 2005/0062226 all of which are incorporated by reference in their entireties. In place of an intelligent shoe, cameras may be used with pattern recognition software to detect what cards have been dealt to what player positions. One method for reading data from playing cards at table games is taught by German Patent Application No. P44 39 502.7. Other methods are taught by U.S. Patent Application Publication 2007/0052167 both of which are incorporated by reference in their entirety. Similarly, cameras may be used to detect when chips, markers, or tokens, are given or removed from a specific player. This information may be helpful should the gaming establishment need to audit a session.

The player station 56 may include a player hand area 74, a betting circle 76, a player tracking mechanism 78, and a player display 80. The player hand area 74 is the area into which the dealer deals the cards for the player. Note that if the shoe 68 cannot or does not track the cards, it is possible to use RFID technology or other image recognition technology to determine what cards have been dealt to the player once the cards have been placed in the player hand area 74. The interested reader is referred to the previously incorporated application 2004/0207156. The betting circle 76 may further be associated with an interrogator so that chips 72 placed in the betting circle may be detected. Another technique to track cards would be to put a card reader in the discard collection area 22.

The player tracking mechanism 78 may be a card reader adapted to receive a magnetic stripe card such as is commonly used in gaming establishments. Alternatively, the player tracking mechanism 78 may be a smart card reader, an RFID interrogator that interrogates a player tracking RFID fob, or other device as desired.

The display 80 may be a display as that term is defined in the Rules of Interpretation and General Definitions set forth below. The display 80 may be a touch screen display and/or have associated input elements such as a keypad or keyboard. Collectively, the display 80 and any associated input elements are termed a player interface. Information about the player, about the session in which the player is participating, or other information may be presented on the display 80 as described herein. In a first embodiment (illustrated), each player station 56 has its own display 80.

In an alternate embodiment, all the player stations 56 at the table 50 share a single display 80 (not shown). Appropriate indicia may be used to distinguish which information relates to which player. In this alternate embodiment, the display 80 may be positioned so that it is readily seen by each player. For example, the display may be vertically mounted proximate the placard 70. In still another alternate embodiment, one or more player stations 56 share one or more displays 80 (not shown). Another variation is to use a mobile terminal such as a personal digital assistant, palm-style computer, cellular phone, hand held or laptop computer as a display.

While not shown, the player station 56 may also include a bill acceptor and/or a cashless gaming receipt device such as the TITO bill validating device such as a FutureLogic GEN2™ PSA-66 device configured to operate within an EZ-PAY™ system by IGT. Still other devices may be added to the table 50 as desired. Likewise, components may be rearranged to improve or discourage access to such components as desired.

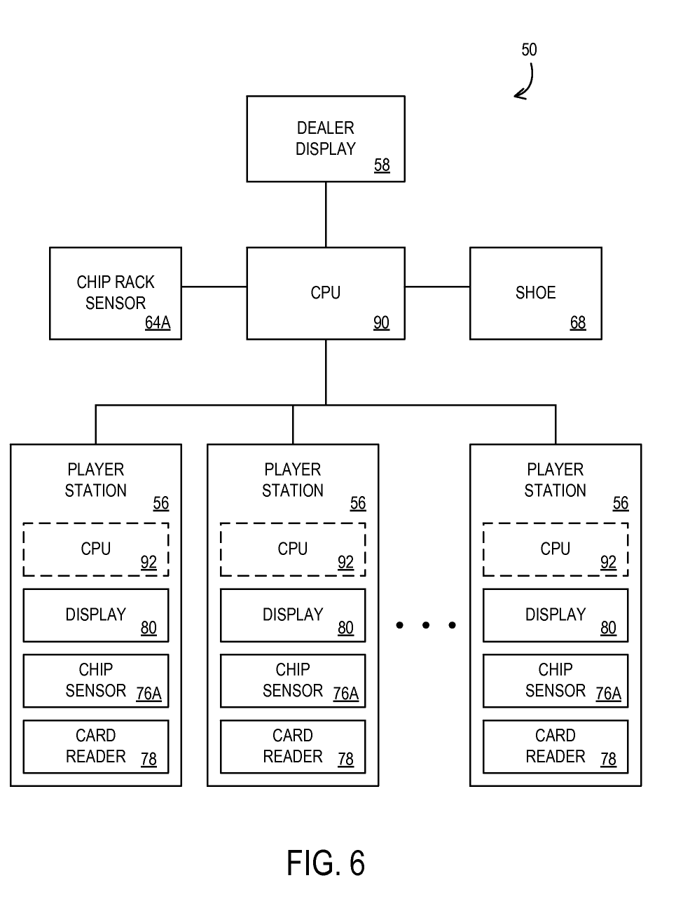

The various electronic components of the table 50 may communicate with one another as better illustrated by the block diagram of FIG. 6. A central processing unit (CPU) or processor 90 may act as the brains of the table 50. The processor 90 is a control system as that term is defined in the Rules of Interpretation and General Definitions set forth below. The processor 90 may be part of the table 50 or may be remotely positioned therefrom. It is possible that the processor 90 may be a central server that controls multiple tables concurrently if desired. The processor 90 may be communicatively coupled to the various components through a network (not labeled) as that term is defined in the Rules of Interpretation and General Definitions set forth below, a bus, or other communication system as desired.

The processor 90 may control all the various components and perform all the calculations according to software stored in a computer readable format in a memory unit (not shown). For example, the processor 90 may receive data from the shoe 68 and or the interrogator associated with the chip rack 64. Such interrogator may be referred to as chip rack sensor 64A. Likewise, the processor 90 may control the player tracking mechanisms 78, the displays 80 and any sensors that track bets such as chip sensors 76A. Chip sensors 76A may be interrogators associated with betting circles 76. Alternatively, functions specific to individual player stations 56 such as control of the display 80, interpretation of data from the chip sensors 76A and the like may be controlled by player station processors 92. As yet another alternative (not illustrated), a single player station processor 92 may control all the player stations and a second processor 90 control the table such that the single player station processor 92 is a client for the processor 90.

While the table 50 is particularly contemplated, it may be possible to modify an existing table to include the functionality of some or all of the embodiments of the present disclosure. For example, PGI, with Shuffle Master and IGT, sells an intelligent table under the moniker INTELLIGENT TABLE SYSTEM™ together with software entitled TABLE MANAGER™. Other intelligent table systems sold by Progressive include the TABLELINK PLAYER TRACKING, TABLELINK CHIP TRACKING, TABLELINK GAME TRACKING, TABLELINK TOTALVIEW, and TABLELINK CUBE. Further intelligent table teachings can be found in U.S. Pat. Nos. 6,676,517 and 7,011,309 as well as U.S. Patent Application Publications 2002/0147042; 2003/0003997; 2005/0026680; 2005/0051965; and 2005/0054408, all of which are incorporated by reference in their entireties.

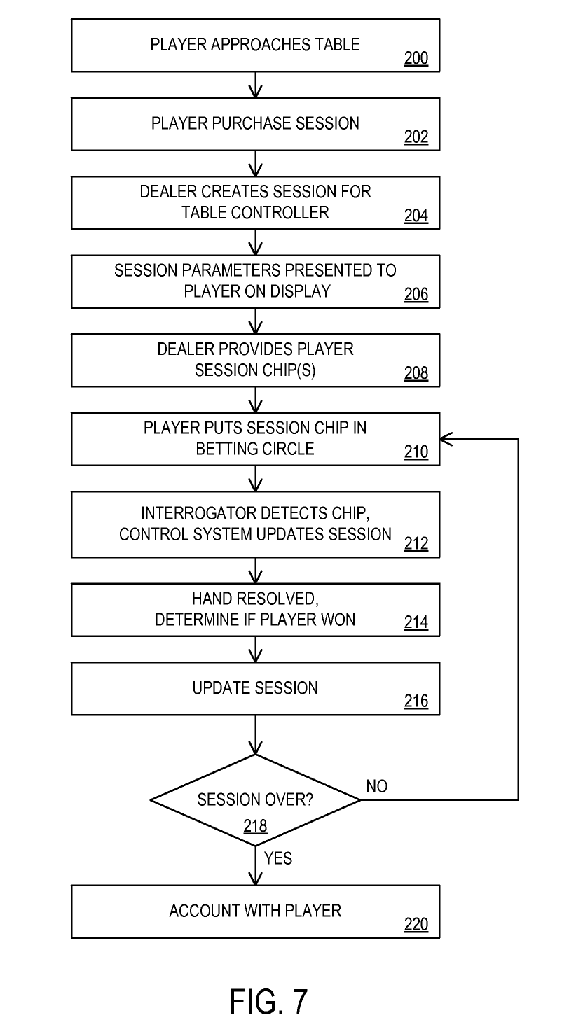

Against such an automated table 50, the dealer's tasks and record keeping associated with the play session are greatly eased and facilitated by the automation of the table. An example of an exemplary method of using such a table 50 is presented with reference to the flow chart of FIG. 7.

As before, the player approaches the table 50 (block 200). The player may view the placard 70, verbally communicate with the dealer, or otherwise become aware of the availability of session play. The player may insert a player tracking card into the player tracking mechanism 78. The player may then purchase a session (block 202). The dealer accepts money or other equity from the player (e.g., by accessing an account associated with the player tracking card or the like) and creates a session for the control system of the table 50 (block 204). The dealer may do this by entering the session information through the dealer display 58 (if it is a touch screen display), through a keyboard, or other input mechanism associated with the dealer station 54. Collectively, the display 58 and its associated inputs (either from the touch screen aspect or the associated input elements) are termed the dealer interface. The session information may be stored in a database or otherwise tracked by the processor 90. Session information may include player position, wager size, number of hands, any ancillary rules associated with the session (e.g., player may not split and/or may not double down). Other information may be included as desired. For example, the session may be associated with the player through the player tracking mechanism 78 so that the player receives appropriate comp points for the session. Note further that in some embodiments, the session may be encoded into a bar code on a cashless gaming ticket. The session may be created by reading the information encoded in the bar code.

The session parameters are then presented to the player on the player display 80 (block 206). Pertinent information may include the player's current balance associated with the session, a number of hands remaining, and other information as desired. The dealer provides the player with one or more session chips 72 (block 208). The session chips 72 have wager values associated therewith as described above. The session chip(s) 72 may be scanned by the dealer with an interrogator to associate the identifier within the chip with the session just purchased by the player. Alternatively, the dealer may type in a chip identifier as part of the process of setting up the session. While linking the session chip(s) 72 to the player and the session are specifically contemplated, such is not required.

The player places one or more session chips 72 in the betting circle 76 (block 210) where the interrogator 76A detects them (block 212). The interrogator 76A communicates the presence of the chip 72 in the betting circle along with an address to the processor 90 so that the processor 90 recognizes that the player at the given player position is playing as part of the session. Likewise, the control system is able to derive the amount wagered by the player based on the information from the interrogator 76A. The processor 90 or other control system operating the method then updates the session information. Specifically, the player's current balance has the value of the wager deducted therefrom, the number of hands is decremented, and any other updates are performed as desired. The information on the player display 80 is updated as well. For example, if the current balance is forty dollars, and the player wagers twenty-five dollars as indicated by five $5 session chips 72, the current balance is decremented to $15.

The dealer and the player resolve the hand, and a determination is made by the processor 90 whether the player won the hand, and if so, what the payout is for the hand (block 214). The processor 90 can determine whether the player is a winner because the processor 90 has received inputs from the shoe 68 and/or the dealer that indicate which player has received which cards compared to the dealer's hand. Resolution of the hand is according to whatever version of blackjack is currently available at the table as modified by any session specific rules (i.e., the rules determine when the dealer must hit, what the odds are, when the player can split or double down, and the like). Based on whether the player won or not, the session information is updated (block 216). For example, if the player won, the balance is updated and displayed. Continuing the above example, if the player wins the twenty-five dollar wager, the balance is now updated to $65.

The processor 90 or other control system determines whether the session is over (block 218) by evaluating how many hands remain for the session. If the answer to block 218 is no, the process repeats as indicated. If however, the session is over, then the dealer accounts with the player (block 220) by providing a payout to the player if the player is owed such. The payout may be in the form of a cashless gaming receipt, a voucher for an amount of money, chips redeemable at a cashier station for cash, or other mechanism as desired. The payout may be based on the current balance for the session.

One mechanism through which the exemplary methodology is facilitated is through the use of a negative credit balance. That is, the player starts the session with a credit balance of zero dollars. If the wager amount is ten dollars, then when the session is updated in block 212, the player's credit balance goes to negative ten dollars. If the player wins, the session balance is updated to positive ten dollars at step 216. If the player loses, the session balance remains at negative ten dollars until the next game start. If the player ends a session with a negative credit balance, the player owes the gaming establishment nothing; the player has already paid for the session, so the player can walk away from the table having experienced entertainment for his expenditure. More detail on the concepts of the negative credit balance for a flat rate play session can be found in U.S. Patent Publication 2007/0087818, which is hereby incorporated by reference in its entirety. Alternatively, a zero-credit floor may be implemented (i.e., the credit balance never falls below zero) or the session may mirror an electronic version of the embodiment of FIGS. 1-3 with the initial balance, running total and final balance.

Note, that during the accounting phase of the method, or when the processor 90 determines that the session is over, the session only chip may be deactivated by the processor 90 and collected by the dealer. Further note that doubles, splits and the like may be processed similarly to the manner described above in that they may be prohibited; they may be allowed only a set number of times; their use may decrement the number of hands the player is allowed in the session; or they may be allowed freely, with the current balance decremented for their use but the number of hands unaffected. In this latter situation, the player may be provided necessary and sufficient number of chips 72 to allow the player to denote each split and double down wager appropriately.

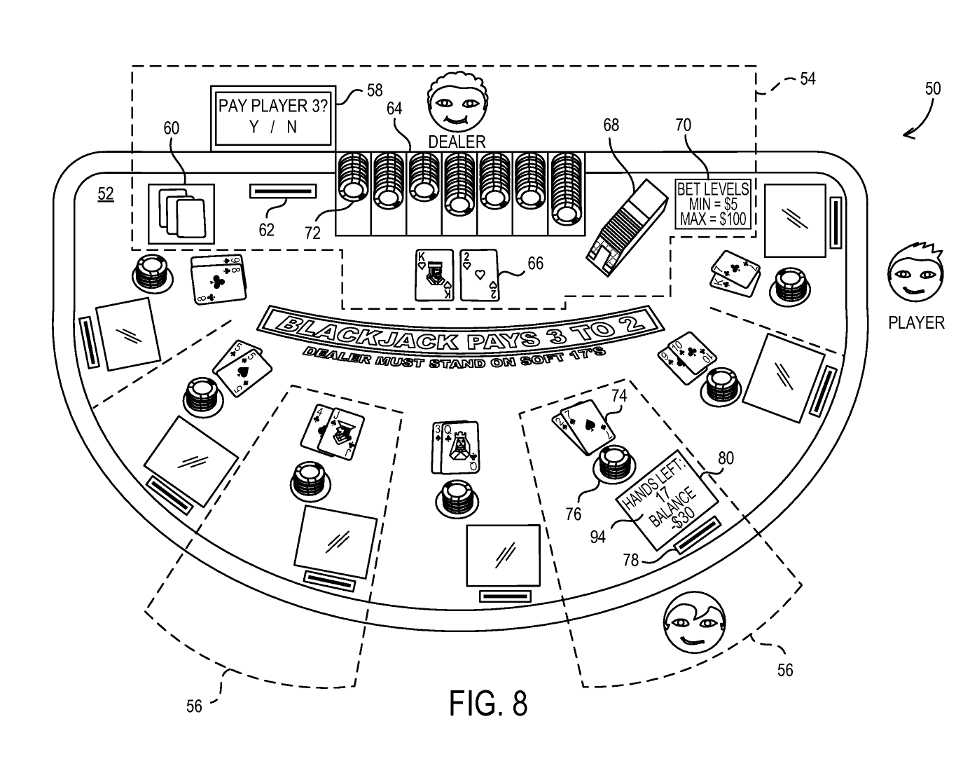

FIG. 8 illustrates an exemplary table 50 in the middle of a session, essentially at block 214. The player display 80 has textual indicia 94 thereon showing the current session balance (negative thirty dollars) and the number of hands remaining (seventeen). As noted above, other information may be included or presented as desired.

In between the simple table 10 and the smart table 50, there are myriad options available that may be used consistently with the present disclosure. For more information, the interested reader is referred to the parent '584 PCT application.

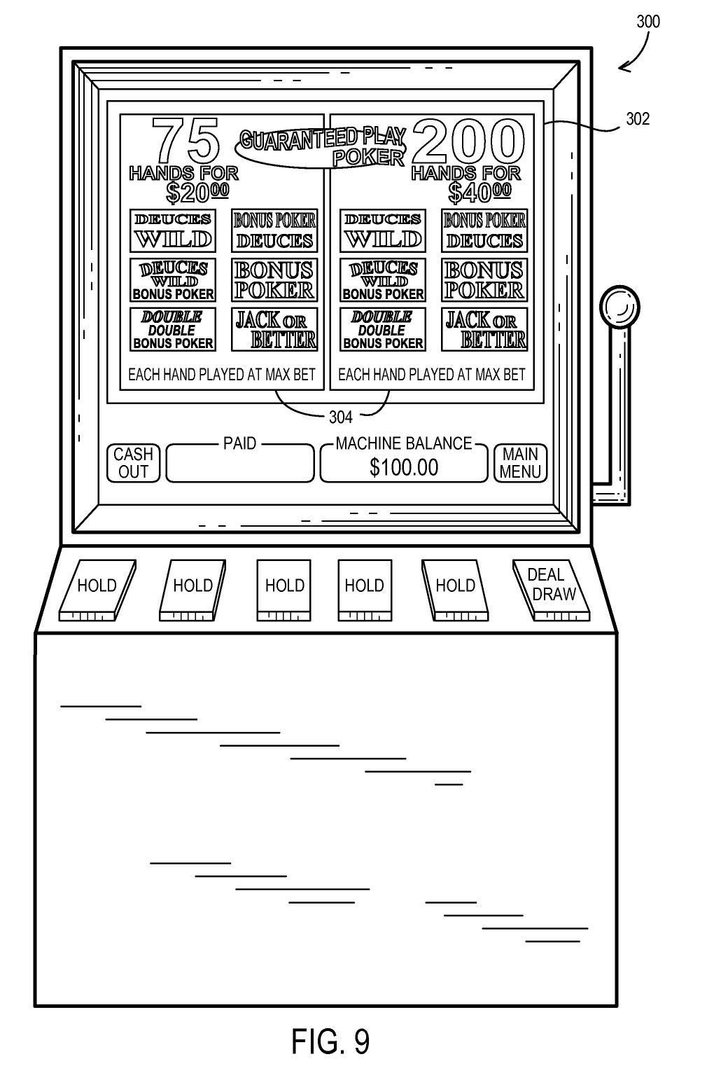

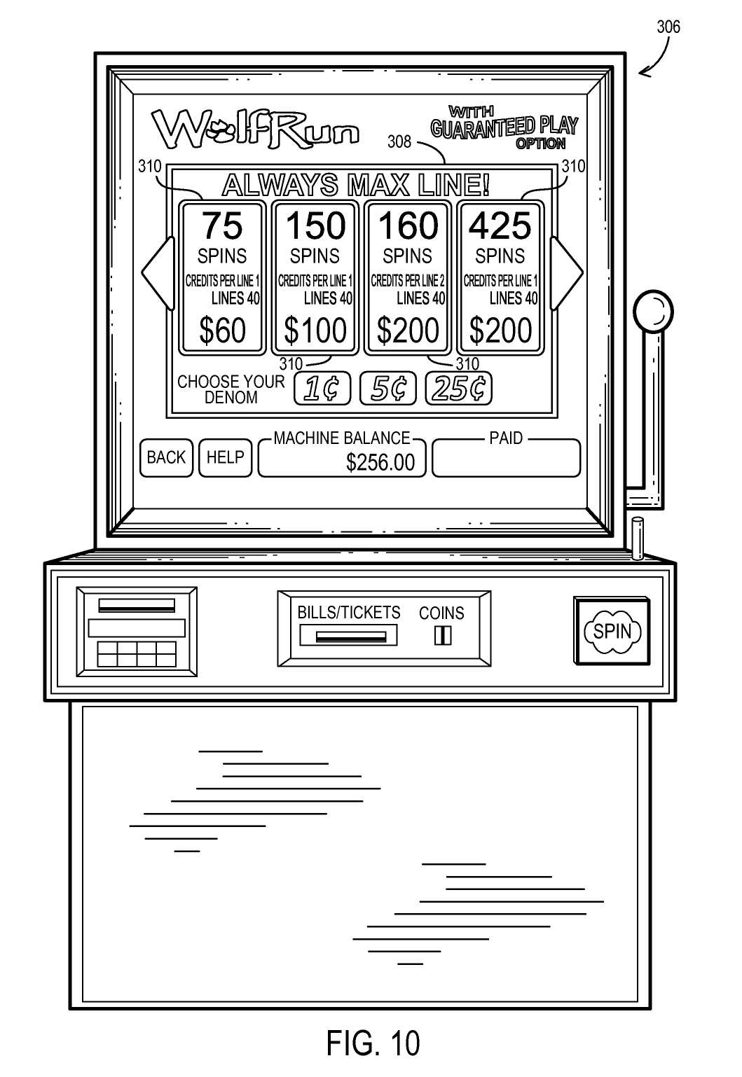

The above discussion has focused on blackjack and particularly on table implemented blackjack. However, the present disclosure is not so limited. The concepts presented herein are also applicable to session play on slot machines, video poker machines, and other gaming devices. An exemplary video poker machine 300 is illustrated in FIG. 9 having a display 302 offering a variety of sessions 304. Likewise, an exemplary slot machine 306 is illustrated in FIG. 10 having a display 308 offering a variety of sessions 310. For more information about various types of sessions on electronic gaming devices as well as a discussion of how pricing of sessions may be determined, the interested reader is referred to the previously incorporated '016 patent application (publication 2006/0040730). However, for simplicity, the rest of the discussion will be with reference to table blackjack.

### Alternate Session Embodiments

There are a number of variations that can be made without departing from the spirit of the present disclosure. It should be appreciated that many of these embodiments are not mutually exclusive and may be mixed and matched to arrive at a product that is still within the scope of the present disclosure. Many of these alternate embodiments are discussed in the parent '584 PCT application, and the interested reader is referred thereto.

A progressive jackpot could be enabled for all session players with a portion of each wager contributing to the progressive jackpot. Alternatively, participation in such a progressive jackpot may require a separate wager. Such an arrangement may encourage players who have deeply negative session balances to continue playing.

In an alternate embodiment, instead of the player purchasing the session through the dealer and the dealer setting up the session, the player may use an input mechanism such as a touch screen feature on display 80 to peruse a menu of available sessions (or to customize a session), select one and pay for the same. The payment may be made to a bill acceptor/cashless receipt acceptor, to the dealer or other manner as desired. In still another embodiment, a player may pre-purchase sessions and associate the sessions with a player tracking account. Such prepurchase could be over the internet, at a kiosk, at a cashier's cage, during check-in, through a server based slot machine, or the like. Then, when the player uses their player tracking device with a player tracking mechanism 58, a list of available sessions for the table (from amongst those prepurchased by the player) is provided on the display 80 and the player may select one. In still another embodiment, the player may use a mobile terminal to select and configure a session. If the player has purchased such a session away from the table, the player may be provided a receipt, other indicia (voucher, marker, token, card, etc.), or the purchase may be associated with the player identifier. The player then presents the receipt, indicia, or player tracking card to the dealer so that the dealer may physically set up the session (e.g., issue chips, set up a balance on a balance meter, issue a lammer, etc.).

Instead of a set number of hands, the session could be defined by time. For example, the player may purchase an hour of blackjack; forty-five minutes of blackjack, not to exceed thirty hands; thirty minutes of blackjack at a rate of one hand per minute; the greater of thirty minutes of blackjack or twenty-five hands; until the dealer is replaced; until the next shuffle of the card shoe; or a predefined block of time (e.g., between 8:00 PM and 10:30 PM).

As a further note, in general, nothing specifically in the present disclosure precludes the player from terminating a session early (i.e., before the number of hands remaining reaches zero). In a first embodiment for such an instance, the player may forfeit the remaining hands. Payouts would be made based on the player's current balance relative to the value of the session. In one embodiment, placement of a conditional bet may trigger early termination of the session.

### Indeterminate Length Session Termination

As alluded to above, it is possible that the session is not measured by the number of hands. One alternate technique suggested above is to measure the session by time. A timer or clock may be used in such situations. While a time based session may be ideal for people who have scheduled events, it may not suit everyone's needs. Thus, another alternate way of measuring the session is to evaluate the occurrence of an event and terminate the session based on the occurrence of a predetermined number of those events.

There are numerous types of potential termination events. The termination event may be a particular card being dealt (e.g., a one-eyed jack), either to the player, to the dealer, or to any person at the table (i.e., any player or dealer). The termination event may be a condition relating to the player's final hand, the dealer's find hand or some comparison between the player's hand and the dealer's hand.

For more information about termination events, the interested reader is directed to the previously incorporated PCT '389 application.

### Increased Volatility

Against that background of hardware, various embodiments of the present disclosure are presented beginning with an overview flow chart in FIG. 11. However a few examples are provided before turning to FIG. 11.

Blackjack may be thought of as a less volatile option for the gambler, especially as compared to other games such as roulette which offer potentially large payouts for small bets. Some players may seek more volatility in a blackjack session, particularly when they are “down” and must reach a threshold chip balance to realize any winnings before a session concludes. Increasing the volatility of the wagers that the player can make effectively increases the cost of the session to the gaming establishment since the gaming establishment's exposure to high payouts is increased. Nevertheless, if the gaming establishment desires to make session play attractive to a wider population of its customers, sessions with high volatility wagers may be provided. To prevent such sessions with high volatility wagers from becoming too expensive, the gaming establishment may impose restrictions or conditions on when the player may make such wagers.

Perhaps the simplest way to control the gaming establishment's exposure is the size of the wager allowed. Almost every table has a maximum wager limit. These limits are in place to limit the maximum payout the gaming establishment may have to make. Similarly, the sessions described above are able to be priced reasonably because of the restrictions on the maximum wager size. Thus, the simplest way to increase the volatility within the session is to increase the size of the maximum wager that the player is allowed to make, or allow the size of the wager to be variable within a predefined range set by the session. However, to keep the cost of the session at a reasonable level, the gaming establishment may limit the amount by which the player may exceed the default maximum wager and may further limit the number of times within the session that the player may place such an enhanced wager. A player would know in advance that she would only be allowed three (for example) higher dollar wagers. However, when the player felt “hot” or felt the dealer was “due” to bust, the player could use one of the higher dollar wagers. For example, if a session is normally fifty hands of $25 maximum wager blackjack sold for $100, then the player may be provided one hand where he can wager $100. The special high wager hand may be denoted by a differently colored play token 42 (e.g., forty-nine green tokens, and one black token) or a specially coded or colored non-cashable chip 34. In yet another variation, a player may be allowed to place a bet with negotiable chips “on top of” his bet with non-negotiable session chips; in other words, players can play hunches by posting additional out-of-pocket currency. Payouts would be made in cashable chips for the cashable part of the wager and session only chips for the non-negotiable portion of the wager.

Another embodiment is the concept of an “end game” wager. When the player reaches the player's last hand (as indicated by the exhaustion of the play tokens, a desire to terminate early, or other technique), the player may indicate her desire to make an “all-in,” “last chance” or end game wager. The player places any remaining play tokens 42 and any remaining non-cashable chips 34 into the wagering circle. If the player is dealt a natural blackjack, the player is refunded the cost of the session (e.g., flat cash purchase price of $20). If the player is dealt anything other than a natural blackjack, the player is paid nothing, but owes nothing. Such an end game wager may be appropriate for a player that is deeply behind and cannot achieve a real payout otherwise. For example, if the player purchased a $20 session of thirty hands of $5 max bet blackjack and received $150 in non-cashable chips, but the player has played most of her hands such that she has only $25 in non-cashable chips 34 and a single play token 42, the player may put all $25 in non-cashable chips 34 and the play token 42 into the betting circle as an “all-in” wager. If she is dealt a blackjack, she gets her initial $20 back, even though under normal circumstances, she would walk away with no payout. Likewise, if a player is behind rapidly, the player may preemptively make an all-in wager to receive her initial expenditure back. This embodiment only makes strategic sense for the player if she is otherwise going to have a payout that is less than the initial purchase price of the session.

In short, the gaming establishment may create conditional bets that allow the players to win more money within the confines of the session. The conditions help control the exposure that the gaming establishment has and help keep the cost of the session reasonable.

Turning now to FIG. 11, an exemplary method is presented in flow chart form. In much the same manner as discussed above, the session starts with the player purchasing the session (block 350). The session is set up according to the terms of the session as previously discussed. However, within this session, the gaming establishment provides one or more conditional bets for use within the session (block 352). Play proceeds as previously discussed until such a time as the player tries to activate the conditional bet (block 354). The control system of the gaming device, the dealer, or other decision maker determines whether to allow the conditional bet (block 356). If the conditional bet is not allowed because the conditions have not been met, then the player may be so informed audibly (e.g., through speakers, from the dealer or other personnel, etc.) or visually (e.g., through text appearing on display 80).

If, however, the conditional bet is allowed, an outcome is determined (block 358) according to the rules of the game and the dealer or gaming device accounts with the player (block 360), such as by providing a payout.

The method presented in FIG. 11 is somewhat simplified, so an examination of the steps is provided in greater detail. It should be noted that the various types of sessions offered and the various types of games on which such sessions are offered have been explored in detail in the incorporated PCT '584 application and the '016 application. Likewise, the mechanics for setting up the session are fully explored in those applications.

There are many different types of conditions that may be used to limit use of high volatility wagers. The simplest conditions conceptually are pre-wager conditions that must be satisfied before the player may place the wager. For example, the player must have a balance below the initial balance of the session before the player can place the high volatility wager. Instead of a condition precedent, there may be a post wager condition that must be satisfied before a payout is provided. For example, the player may not cash out until a number of game plays are completed after the conditional wager is made (this rule is an exception to the general rule that there is no prohibition against early cash outs). For example, a player exercises a conditional bet and then may not cash out for five additional game starts. Both post wager and pre wager conditions are contemplated within the scope of the present disclosure.

In addition to the various conditions, there are different types of conditional wagers that may be offered for use within the session. Conditional wagers may provide flat monetary or variable payouts. Examples of flat monetary payouts include, but are not limited to: flat odds (e.g. 1:1) on a wager that exceeds the session's normal maximum wager (e.g., the player bets $50 in a session where the wager is normally capped at $5); the player wins a sum certain number of credits (e.g., 100 credits); and the like. Variable payouts may be based on one or more session parameters such as credit balance, setting the payout such that the session balance is a predetermined amount after the payout (e.g., regardless of session balance when the wager is placed, if the player wins, the session balance is changed to one hundred credits, which may or may not be the initial balance with or without the price of the session included), setting the session balance to twice an absolute value of the session balance prior to the conditional bet, setting the session balance to a predefined portion of its original amount, duration of time remaining, number of consecutive wins/losses the player has obtained, the timing of the wager relative to beginning or end of the session, a randomly generated number (e.g., a random number generator provides in whole or in part, the payout amount), or the like.

There are many conditions that can be imposed on the conditional wagers. Some of these conditions are alluded to above. Other conditions may be events within the game such as a player receiving a conditional bet trigger hand (e.g., a hand containing a suicide king or two sevens may trigger the option for the player to place the conditional bet), winning a predetermined number of game starts, losing a predetermined number of game starts, or the like. Player status may be used not only to improve a payout on a conditional bet, but also to qualify for a conditional wager at all.

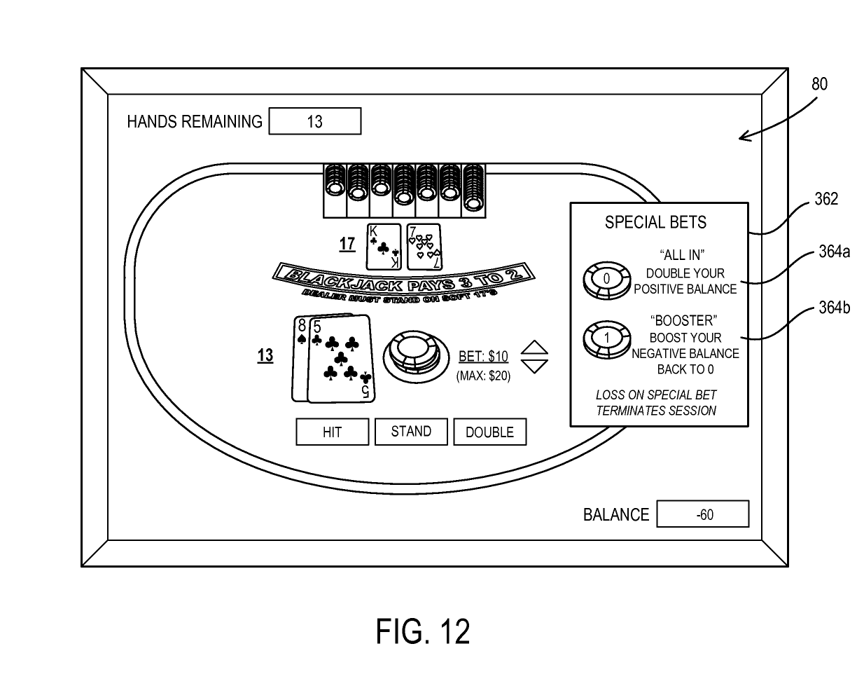

To be fair to the players, the rules associated with the conditions may be posted or otherwise provided to the players. Exemplary techniques for providing the rules to the player include, but are not limited to placards, an electronic display such as display 80, a communal display (not shown), graphics and/or text on the felt of a table top, or the like. While it is contemplated that only a single type of conditional bet may be associated with a session, it is possible that multiple types may be associated with a session, each having different conditions or payouts. While it is further contemplated that only one conditional bet would be available at any given time within the session, it is possible that multiple conditional bets may be available concurrently. An exemplary screen shot of screen 80 is provided at FIG. 12 showing a pop up 362 with two conditional wager terms 364a and 364b thereon. It is possible to display all conditional wagers all the time, but indicate through highlighting, illuminating an associated LED, graying out, or otherwise visually distinguishing available bets from unavailable bets. Payouts may also be indicated for each conditional wager so that the player knows what the benefit or disadvantage of placing a conditional wager is.

Because conditional bets may slow game play, a player may be provided a timer that counts down on a window of time available to the player in which to place a conditional wager.

Note that while it is contemplated that the conditional wager may be provided as part of a session, it is possible that a player purchases or receives a conditional wager separately from the session, such as through a kiosk, cashier's cage, player reward program booth, player reward mailing, a point of sale, or other location as desired. Such locations may provide help menus to explain the nature of the conditional wager, when the conditional wager may be used, and payouts associated with the conditional wager. Players may have to indicate that they have read the rules associated with the conditional wager before being sold the conditional wager in a manner akin to a click-through license agreement. In some embodiments, the player may be provided some physical element that denotes the availability of the conditional wager. This physical element may be a chip, a lammer, a token, a receipt with a bar code, or other device as desired. If the session is being played on an electronic gaming device the physical element may be represented virtually (e.g., as a graphical token, as a displayed credit in an electronic balance of conditional wagers, or the like). Alternatively, the physical element could be a printed receipt that is inserted into a bill acceptor and then converted to a virtual element.

The player may indicate the conditional wager through a variety of mechanisms. In an electronic gaming device, the player may press a button corresponding to the conditional wager, touch a touch screen button, drag an icon to a particular location on a screen, enter a bet amount greater than the normal maximum bet, or insert a receipt having indicia relating to the conditional wager into a cash acceptor or the like. At a table, the player may provide a physical element denoting the conditional wager. This physical element may be inserted into a receipt reader, handed to the dealer, placed in the betting circle, or otherwise provided. Still further, the player may orally indicate to the dealer that the player desires to place the conditional wager. If RFID technology is in use, the interrogators may detect an RFID physical element as desired.

Once the conditional bet is detected, the control system, dealer, pit boss, supervisor, or other decision maker may determine whether to allow the conditional bet. In an electronic gaming device, this determination may be easy because the player may not be able to provide an input indicative of the conditional bet if the player is not allowed to make the conditional bet (e.g., the conditional bets are grayed out until allowed). Alternatively, the control system or decision maker may determine whether the player has the particular type of conditional bet in inventory based on the initial parameters of the session. If physical elements are used, then the provision of the physical element is indicative that the player still has the conditional bet in inventory, although inspection of the physical element to detect a fraudulent physical element is within the scope of the present disclosure. In an electronic device, a database may track the player's use of the conditional bets to determine whether the player still has conditional bets in inventory.

The control system or decision maker further determines whether the conditions associated with the conditional wager have been met. While examples are provided above, more exemplary conditions are set forth herein including that the player may only use a conditional wager when the player has a negative balance, when the balance is within a certain range (e.g., −100 to 100 credits), at a certain temporal point in the session (e.g., ten or fewer hands remaining), time or game starts elapsed since the last conditional bet, qualifying for a bonus round within a game, the player has wagered a certain amount, the player has a certain inventory of conditional wagers per session (e.g., the player has five double maximum bets per session), the player may place a conditional wager every X hands, every X consecutive wins, every X consecutive losses, every $X of loss, every X minutes, or the like. In some embodiments, conditional wagers may be non-optional. For example, a player must go all-in at least once a session, where failure to do so results in a penalty, either monetary through a tax at the end of the session, a commission, or the like.

Determination of the outcome may rely on determination of the outcome of the primary game (e.g., whether the player's hand beat the dealer's hand in blackjack). A further condition may be that not only must the player win the primary game, but win in a way that satisfies a condition (e.g., beat the dealer hand by two in blackjack). Instead of the primary game, the outcome of a secondary game may be used (e.g., an additional hand of poker is played after the blackjack hand, and if the player wins the poker hand, then conditional wager is won). Bonus games within electronic gaming devices could also be used.

Based on whether the conditional wager was successful, a payout may be determined. Payouts may be stored in a database for this purpose, posted on a paytable, or the like. If the payout was a fixed payout, then the fixed payout may be provided, although the fixed payout may still be a function of the amount wagered and be considered a fixed payout (e.g., paying 1:1 in blackjack on a wager that exceeds the normal maximum may still be considered a fixed payout). For variable payouts, the variable must be evaluated. For example, if the variable payout is a balance reset, and the player has a balance of −120 credits, the payout is 120 credits. Another example would be a 50% balance boost wager, where, if the player had a balance of fifty credits, the payout would be twenty-five credits.

Once the outcome is determined, the dealer or the game accounts with the player and updates the player balance. In a physical game, the player is provided chips corresponding to his outcome (or chips are collected from the player for a losing wager). In an electronic game, a session balance is adjusted using techniques known in the art. The adjustment may be automatic or may be made on command of a representative of the gaming establishment. Still other techniques of balance adjustment may be possible. For example, on a smart table 50, an electronic balance may be adjusted concurrently with or in place of chips being issued or a receipt being printed.

If the player lost the conditional bet, the wager amount is subtracted from the balance. If the player was wagering a fixed amount, that fixed amount is subtracted. If the player is wagering a variable amount (e.g., an all-in wager), then the balance is adjusted according to the variable.

In some embodiments, there may be a non-monetary effect. For example, the player may win additional game plays or have the session extended. Likewise, the player may lose game plays or have the session time reduced. In another example, a player successfully placing a first conditional wager may win the right to place a second conditional wager. As noted above, there may be post wager conditions such as, for example, that the player cannot cash out for another ten game starts. Another non-monetary effect is that the player may be advanced to a different type of session. For example, if the player started at a five dollar maximum bet session, then the player may be advanced to a ten dollar maximum bet session. Still another non-monetary award might be comp points or the like.

### Variable Value Session Chips

In some embodiments, the face value of chips provided for use in a table gaming session may change based upon certain conditions. Conditions that may affect the value of such chips include: a count of the balance of chips (e.g., chips are worth more when players have fewer, or when beneath a cashout threshold or deductible, etc.); a measure of the time, hands or termination counters left in the session (e.g., chips are worth less at the beginning of a session); cards or outcomes obtained within the session; a number of chips wagered; etc. In one embodiment, a display device associated with a betting chip may dynamically indicate its changing face value, as described in Applicant's co-pending U.S. Provisional Patent No. 60/826,977, filed Sep. 26, 2006 and entitled GAMING CHIP WITH DISPLAY, the entirety of which is incorporated by reference for all purposes.

### RULES OF INTERPRETATION AND GENERAL DEFINITIONS

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

A player “wagers” at least a single “unit of wager” to pay for a game start. In many gaming devices, a unit of wager may be referred to as a credit. Many gaming devices allow multiple credits to be wagered concurrently in exchange for an improved paytable or more paylines. A unit of wager may be equivalent to a full dollar amount ($1, $5), a fractional dollar amount, a coin (e.g., $0.05 (nickel) or $0.25 (quarter)), or specified amount of another currency (e.g., a specified number of comp points). Some paytables may be expressed as a number of coins won relative to a number of coins wagered. In such instances, the term coin is the same as a unit of wager. Because gaming devices are embodied in different denominations, it is relevant to note that a coin, credit, or unit of wager on a first device may not be identically valued as a coin, credit, or unit of wager on a second device. For example, a credit on a quarter slot machine (on which the credit is equivalent to $0.25) is not the same as a credit on a five dollar slot machine (on which the credit is equivalent to $5.00). Accordingly, it should be understood that in embodiments in which a player may cash out credits from a first gaming device that operates based on a first denomination (e.g., a quarter-play slot machine) and establish, using only the cashed out credits, a credit balance on a second gaming device that operates based on a second denomination (e.g., a nickel-play slot machine), the player may receive a different number of credits on the second gaming device than the number of credits cashed out at the first gaming device. An interesting discussion of this concept can be found in U.S. Pat. No. 5,277,424, which is hereby incorporated by reference in its entirety.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure frequently refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

What is claimed is:

1. A method comprising:
defining a session of game play comprising a plurality of game starts of a wagering game provided to a player for a predefined price to be paid prior to the session beginning;
conducting game play according to rules of the session including offering to a player of the session an opportunity to place a conditional bet;
receiving an indication from the player that the player is placing the conditional bet within the session;
determining whether to allow the conditional bet; and
determining an outcome for a game start on which the player has placed the conditional bet.

2. The method of claim 1 further comprising establishing a session balance for the player.

3. The method of claim 2 further comprising decrementing the session balance at each game start.

4. The method of claim 2 further comprising incrementing the session balance for any game start within the session on which the player has placed a winning wager.

5. The method of claim 2 further comprising setting the session balance to zero initially.

6. The method of claim 2 further comprising allowing the session balance to be negative.

7. The method of claim 2 further comprising setting the session balance to a particular amount if the conditional bet is a winning bet.

8. The method of claim 7 further comprising resetting the session balance to a balance equal to the predefined price if the conditional bet is a winning bet.

9. The method of claim 7 further comprising setting the session balance to twice an absolute value of the session balance prior to the conditional bet if the winning bet is a winning bet.

10. The method of claim 7 further comprising resetting the session balance to a predefined portion of its original amount if the conditional bet is a winning bet.

11. The method of claim 2 wherein determining whether to allow the conditional bet comprises determining whether the session balance is below a predetermined threshold.

12. The method of claim 2 wherein determining whether to allow the conditional bet comprises determining whether the session balance is within a predefined range.

13. The method of claim 1 wherein defining the session of game play comprises defining a session of table game play.

14. The method of claim 1 wherein defining the session of game play comprises defining a session of game play for an electronic gaming device.

15. The method of claim 1 wherein defining the session of game play comprises defining a session of game play embodied at least in part in a mobile terminal.

16. The method of claim 1 further comprising accepting payment from the player for the session.

17. The method of claim 1 further comprising a default maximum bet for each game start within the session.

18. The method of claim 17 wherein the conditional bet is greater than the default maximum bet.

19. The method of claim 1 further comprising providing a payout of 1:1 relative to the conditional bet if the conditional bet is a winning bet.

20. The method of claim 1 further comprising providing a payout equal to the predefined price if the conditional bet is a winning bet.

21. The method of claim 1 wherein determining whether to allow the conditional bet comprises determining whether a number of game starts below a threshold remain in the session.

22. The method of claim 1 wherein determining whether to allow the conditional bet comprises determining whether the player has lost a predetermined number of game starts.

23. The method of claim 1 further comprising allowing the player to cash out the session balance at the end of the session.

24. The method of claim 23 further comprising placing restrictions on cashing out the session balance prior to the end of the session.

25. The method of claim 1 further comprising extending the session if the player places the conditional bet.

26. The method of claim 1 wherein determining whether to allow the conditional bet comprises determining whether the player has purchased an option allowing the conditional bet.

27. The method of claim 1 further comprising displaying a list of conditions that satisfy the condition required to make the conditional bet.

28. The method of claim 1 further comprising indicating to the player that the player is eligible to make the conditional bet.

29. The method of claim 1 further comprising providing the player with a token to indicate placing the conditional bet.

30. The method of claim 29 wherein receiving the indication comprises receiving the token back from the player.

31. The method of claim 1 wherein receiving the indication comprises receiving the indication through an electronic user interface.

32. A system comprising:
a user interface; and
a control system operatively coupled to the user interface and adapted to:
define a session of game play comprising a plurality of game starts of a wagering game provided to a player for a predefined price to be paid prior to the session beginning;
conduct game play according to rules of the session including offering to a player of the session an opportunity to place a conditional bet;
receive an indication from the player that the player is placing the conditional bet within the session;
determine whether to allow the conditional bet; and
determine an outcome for a game start on which the player has placed the conditional bet.

33. A computer readable medium comprising software with instructions to:
define a session of game play comprising a plurality of game starts of a wagering game provided to a player for a predefined price to be paid prior to the session beginning;
conduct game play according to rules of the session including offering to a player of the session an opportunity to place a conditional bet;
receive an indication from the player that the player is placing the conditional bet within the session;
determine whether to allow the conditional bet; and
determine an outcome for a game start on which the player has placed the conditional bet.
